(19) United States
(12) Patent Application Publication
(10) Pub. No.: US 2013/0013428 A1
(43) Pub. Date: Jan. 10, 2013

(54) METHOD AND APPARATUS FOR PRESENTING OFFERS

(75) Inventors: Clifford Lyon, Melrose, MA (US); Ned Rhinelander, Melrose, MA (US)

(73) Assignee: CBS INTERACTIVE INC., San Francisco, CA (US)

(21) Appl. No.: 13/178,693

(22) Filed: Jul. 8, 2011

(51) Int. Cl. G06Q 30/02

(52) U.S. Cl. 705/14.73

(57) ABSTRACT

At a computing device, an offer for an inventory item directing a user to at least one advertiser site is received. At least one attribute associated with the offer is determined. At least one tag is assigned to the offer based on the determined at least one attribute. At least one matching publisher site is selected based on at least one factor, wherein the at least one factor includes the at least one tag.

### RELATED APPLICATIONS

This application is related to the patent applications U.S. Ser. No. 12/895,075 filed Sep. 30, 2010, U.S. Ser. No. 12/792,029 filed Jun. 2, 2010, U.S. Ser. No. 12/951,247 filed Nov. 22, 2010, and U.S. Ser. No. 12/950,169 filed Nov. 19, 2010, the disclosures of which are all incorporated herein by reference.

### COPYRIGHT NOTICE

A portion of the disclosure of this patent document contains material which is subject to copyright protection. The copyright owner has not objected to the facsimile reproduction by anyone of the patent document or the patent disclosure, as it appears in the Patent and Trademark Office patent file or records, but otherwise reserves all copyright rights whatsoever.

### TECHNICAL FIELD

The present document relates to content aggregation and optimization over a network, and more particularly, to gathering offers having a monetary value, tagging offers with metadata, and optimizing the display of offers to maximize revenue.

### BACKGROUND

The Internet connects the world marketplace by joining consumers to products and services that represent various entities, information, and resources. The growth of the Internet has created many opportunities for advertisers, product developers, and other market participants (collectively, “service providers”) to uncover content and other resources related to the world-wide web of the consumer world. Consumers and providers communicate electronically, often exchanging resources and conducting electronic commerce. These connected consumers and the service providers form enormous banks of resources, resulting in a world wide web of consumers. Web technology has made it possible to target information and resources to consumers with specific interests. These service providers store and access data, documents, and Web pages containing various commercial content.

Included in these banks of resources is a vast inventory of offers and items, such as products and services made available through electronic commerce transactions. Much of the buying and selling of products or services occurs over electronic systems such as the World Wide Web or other computer networks. With the proliferation of online shopping, more consumer information and inventory data is made available online than ever before.

Due to the proliferation of online shopping and availability of online inventory, consumers with specific interests, and indirectly the service provider who provides inventory items related to specific interests, are targeted to make the exchange of information and electronic commerce more efficient. Consumers receive materials related to their interests, while topics and materials in which they are not interested are sent to others. Targeting consumers reduces the burden on consumers who may ultimately consume products and services of the Web service providers. Additionally, by properly targeting likely consumers, service providers may more efficiently focus their marketing and sales efforts.

As more information is collected and the banks of commercial content grow, it becomes more difficult to sort, identify, and track the inventory items online. Thus is becomes more difficult to customize the selection of offers to return information relevant to the target customers or service providers. Duplication of offers and other information about the inventory also become problematic when selecting relevant offers. Such inefficiencies may result in delays in getting offers to target consumers or service providers and inaccuracies when serving offers to target consumers.

Therefore, there is a need for collecting and consolidating inventory information and offers and in matching such information to target consumers or service providers based on relevant targeting of consumers or service providers.

### BRIEF DESCRIPTION OF THE DRAWINGS

FIG. 1 is a block diagram of a monetization network system, according to some embodiments.

FIG. 2 is a block diagram of a monetization system for categorizing and matching offers, according to some embodiments.

FIG. 3 is a block diagram illustrating the operational components of a monetization system, according to some embodiments.

FIG. 4 is a flow diagram illustrating the operation of a monetization system, according to some embodiments.

FIGS. 5A and 5B are block diagrams illustrating subcomponents of the monetization system, according to some embodiments.

FIG. 6 is a screenshot illustration of various displays of offers, according to some embodiments.

FIG. 7 is a block diagram of a system architecture for implementing the method according to one embodiment.

FIG. 8 is a block diagram of a computer system according to one embodiment.

FIG. 9 is a flow diagram illustrating the operation of an offer monetization system, according to some other embodiments.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the embodiments described herein are provided by way of example and should not be used to limit the scope of the subject matter to these embodiments. In other instances, well-known data structures, timing protocols, software operations, procedures, and components have not been described in detail so as not to unnecessarily obscure aspects of the embodiments of the subject matter described herein.

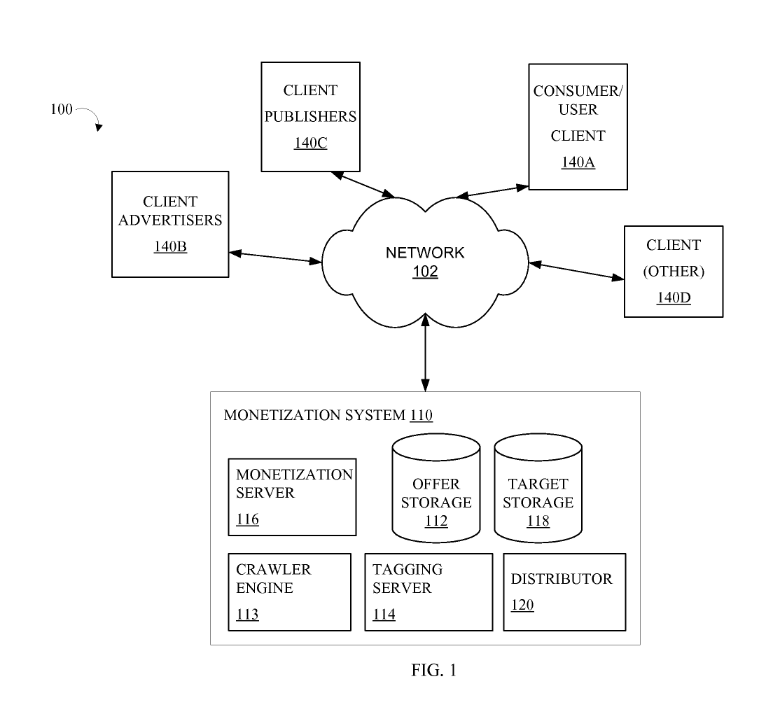

FIG. 1 is a block diagram of a network system 100 (also referred to as a digital content environment) that includes a monetization system according to some embodiments. The network system 100 includes one or more client devices 140. Users at the client devices 140 may be consumers 140A, advertisers 140B, publishers 140C or any other user 140D connecting to a network 102 for communicating with a monetization server system 110. Other users 140D may include, for example, a user who is both a consumer and advertiser, who may have an interest in viewing offers and posting offers for others to view. The monetization server system 110 gathers and pools offers from various content sources on the Internet, such as from advertisers 140B who create the offers. The monetization server system 110 tags and categorizes the collected offers, matches the offers to one or more destination pages, and distributes the offers accordingly. An offer may be any content that can be suitably formatted by the monetization server system 110 and has some known dollar value in which a commerce transaction can occur. The offer may be a single piece of content or comprise one or more content items that collectively define the offer. An offer may be recognized in any manner on the Internet, for example, based on having a headline, a body, and/or destination uniform resource locator (“URL”). Offers may be advertisements, announcements, links to reseller transactions, documents, video content, audio content, and so on. These offers may be associated with physical products, services or anything that can be purchased, registered or paid for can be identified as an offer. Offers can be made for electronic products, web services, content, documents, and so on. For example, offers can be products sold or featured on Amazon, advertisements on Google, whitepapers, iTunes, electronic books, programs (movies, television, music, and so on). Tagging can be accomplished using methodologies described in U.S. patent application Ser. Nos. 12/895,075, 12/792,029, 12/951,247, and 12/950,169, the disclosures of which are incorporated herein by reference.

Offers, once tagged and categorized, may be matched to one or more web pages located at one or more publishers 140C, who in return may serve the offers to their subscribers or users at various client locations 140A, 140D. It will be appreciated that offers may be published on any type of web page including, but not limited to, publishers, advertisers, personal web pages, social networking postings, review pages, white papers, email, search result lists from a search engine, web pages navigated from a search result list and so on, collectively known as “publisher sites” or “publisher websites”.

In some embodiments, offers may be matched directly to one or more users at client devices 140 who access websites maintained by publishers 140C or client devices 140 that may access publisher websites. Client devices 140 can be any of a number of devices (e.g., a computer, an internet kiosk, a personal digital assistant, a cell phone, a gaming device, a desktop computer, or a laptop computer). Each client device 140 may include one or more software applications and memory that permits a user at the device to interact with other clients and/or network resources for performing one or more tasks. For example, the client device 140 may include a web browser or other types of applications that permit a user to interact with or receive information and services from advertisers 140B, publishers 140C, and/or the monetization server system 110. The client applications may also include those that perform one or more tasks related to monitoring or assisting a user's activities. In some embodiments, the client device 140 includes applications that are available as a plug-in or extension to applications provided, for example, from various online sources, while in other embodiments the applications may be stand-alone programs.

In some embodiments, the publisher site has been determined by the user. For example, offers may be matched to the publish site based on the user navigating to that site. A number of factors may be considered for determining which offers are selected for publishing on the visited site. The monetization server system 110 may select the offer with the strongest association to the page the user has navigated to in order maximize relevance or potentially to maximize the dual objective of user relevance and publisher profit.

The monetization server system 110 includes offer storage 112, a crawler engine 113, tagging server 114, monetization server 116, target storage 118, and distributor 120. Crawler engine 113 searches various content sources throughout the internet for offers and updates to offers, and stores offer content in data storage 112. Crawler engine 113 may automatically venture to various content sources, may be automated to crawl certain sites based on a predetermined schedule, or may be manually instructed to conduct a crawl for offer content. Tagging server 114 analyzes the content in storage 112 based on filters and one or more algorithms, the processes of which are described in detail in U.S. application Ser. No. 12/950,169, and is hereby incorporated by reference. Each offer is accordingly tagged and categorized based on the analysis to allow for offers to be matched to publisher URLs according to relevance. In some embodiments, one or more tags may be associated with an offer, or each content item of an offer (offer content) may be associated with one or more tags. The tags associated with the offer content may collectively be the one or more tags associated with the offer.

The crawler engine 113 additionally gathers information related to target sites, such as destination URLs, and stores the information in storage 118. Information related to destination URLs may include any information about a target user, target site or target subscriber that may be used to match offers, for example, based on relevance. Target sites or target subscribers may be publishers 140C who subscribe to the monetization server system 110 service. Target users may also be consumers who subscribe to one or more websites of the publishers 140C. In some embodiments, a single storage location may be utilized to store data for the entire system 110, e.g., both offer data and target data stored at the same location. In other embodiments, storage of the offer data and target data may be distributed across multiple storage locations. In yet other embodiment, data for the server system 110 may be stored and/or serviced at an external location.

The monetization server 116 synthesizes the gathered data on offers and targets to generate relevant matches of offers to display at target sites. For example, the monetization server 116 utilizes the offers tagged and categorized by tagging server 114 and stored in storage 112 to match relevant offers to target sites stored in storage 118. The monetization server 116 considers one or more factors in one or more algorithms or filters to determine the matches, and includes relevance calculations and profitability determinations. Relevance may be determined by a number of factors, such as age of the offer, updates, or modifications to offers or offer content, profitability, bids placed by subscribers or targets, and so on.

The monetization server 116 additionally considers the relevance associated with the user or attributes of the web page a user has navigated to. Offers may be matched based on any number of factors that will provide the strongest association to the page the user has navigated to in order maximize relevance or potentially to maximize the dual objective of user relevance and publisher profit. Such relevance factors for determining the best matched offers to a web page include, but is not limited to, attributes such as user data or user profile information (e.g., number of clicks), content in or relating to publisher and/or advertiser landing pages (e.g., one or more topics within the web page, the number of times a user has visited a page, frequency of clicks on an embedded link), user history associated with the web page, and so on.

The monetization server 116 may also conduct maintenance on the data in storages 112, 118 to ensure that duplicates are omitted and content is updated regularly to ensure the latest offers and the most recent data are considered for the matching.

The distributor module 120 tracks the location of publisher pages and manages the transference and display of offers at the matched publisher pages. In some embodiments, the distributor module 120 communicates with publishers 140C and supplies offers to be displayed by the publishers 140C. In some embodiments, the distributor module 120 accesses destination URLs directly to upload offer information at various client sites 140.

It will be appreciated that the server system 110 may include one or more computing devices, and that the one or more computing devices may provide a combination of the services described above. For example, in one embodiment, a single server device may provide the tagging, matching, and distributing operations described above. In other embodiments, one or more of the operations described above may be provided by one or more computing devices. The various functions can be accomplished by one or more devices and can be segregated amongst devices in any manner.

The network 102 may be any wired or wireless local area network (LAN), metropolitan area network, and/or wide area network (WAN), such as an intranet, an extranet, or the Internet, or it may be a combination of such networks. It is sufficient that the network 102 provide communication capability within the monetization server system 110. In some embodiments, the network 102 uses the HyperText Transport Protocol (HTTP) to transport information using the Transmission Control Protocol/Internet Protocol (TCP/IP). The HTTP permits client computers to access various documents available via the network 102. The various embodiments, however, are not limited to the use of any particular protocol.

The term “content” as used throughout this specification refers to any piece of content, information or service that is identified, stored, retrieved or located by the monetization server system 110, and may be, for example, a web page, a file of certain format, a database record, audio, video content, an image, a computational object, or other information items. The term “offer content” as used throughout this specification, thus, may refer to content or content items of an offer or any content relating to, associated with, or that qualifies a respective offer.

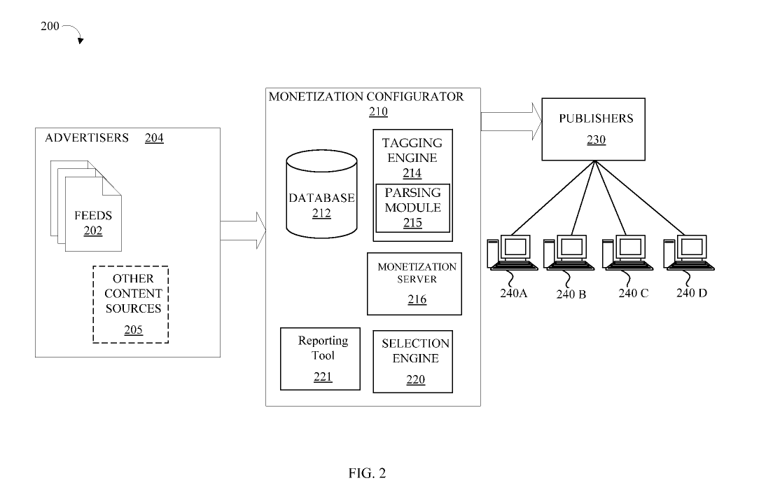

FIG. 2 is a detailed block diagram of a monetization system 200 for tagging, categorizing, and matching offers to publisher pages. The monetization system 200 includes advertisers 204 who provide offers to be collected by a monetization configurator 210. The monetization configurator 210 allows advertisers 204 to submit paying offers, and provides a way for publishers 230 and/or users to receive offers relevant to their pages and/or user demographic.

Offers are supplied in a feed 202 of inventory items that the advertisers 202 desire to promote. The feeds 202 may contain one or more offers (e.g., relating to products, services, or other items) created by the advertisers 204. Each offer in the feed contains one or more fields for display of some advertisement or ad type. In some embodiments, the displayed ad type must generate revenue and have a known value, e.g., paying offers. The items of inventory or inventory items described herein can be any items such as tangible products, services, digital content or the like.

Offers supplied on a feed may come from a number of different sources. Offers may be from indirect sources such as unsold inventory items from ad systems or networks that may be proprietary or not, inventory items first offered to other advertising networks such as Google adsense, or advertisement links from existing subscribers and/or publishers 230. Although these offers may be consolidated onto one or more feeds 202, offers may be acquired directly from other content sources 205.

Content in the feeds 202 may be displayed in a variety of ways. For example, feeds 202 allow the addition of new offer attributes in an easy way (e.g., images). Feeds 202 may be located by an associated URL, and may be recognized by text or code found in its URL Any part of the URL links associated with the items in the feed 202 may be tagged. Feeds 202 may also include within item element text that may be used for tagging in lieu of or in addition to extracted text from the URL link.

Other content sources 205 may also qualify as advertisers 204. Other content sources 205 can be any source such as, but not limited to, websites, RSS feeds, blogs or other user generated content, social networks, catalog data, document management systems or the like holding content related to one or more offers. These other content sources 205 can also be tagged based on any information, such as embedded text or code, in or associated with a URL link. Other sources 205 may be documents, white papers, images, audio/video content, webpages and web service locations, and so on, which contain content having recognizable attributes capable of generating some revenue, and has a known value.

In some embodiments, offers may be collected in an automated manner. For example, web crawlers may be scheduled to crawl various content sources 202, 205 of advertisers 204 at various web locations, or to return to web locations for updated content.

Thus, the monetization configurator 210 may be configured to update offers or offer content previously collected. For example, when the monetization configurator 210 returns to a feed 202, any updated offers or offer content will replace the offers previously loaded from that feed 202. Offers and offer content may be updated based on recent feeds that were crawled. Feeds 202 may be read or crawled automatically based on a predetermined schedule, e.g., hourly. Crawling feeds 202 may also be manually initiated or a combination of automated and manual crawls.

The monetization configurator 210 stores the offers and associated content in database 212. The data schema for storing offers should be flexible enough to allow easy creation of new attributes (as in the images example above), and storage of arbitrary tag-based features or unstructured attributes. Offers that are mined from the advertisers 204 are initially stored, and then they are stored again or updated by tagging engine 214 once the offer has been tagged.

It will be appreciated that database 212 may be a single storage unit or comprise multiple units, such as offer storage 112 and target storage 118. Database 212 may additionally store other information such as tracking data, management information, templates, and any other information utilized by the monetization configurator 210. In some embodiments, database may be located, in part or in whole, at a location external to the monetization configurator 210 or managed by a third party service.

As feeds 202 are processed, associated URL links are passed through the monetization configurator 210 to be further processed by tagging engine 214 to attach metadata to each offer. Metadata may affect the type of tag or weights assigned to the feed or contents of the feed, such as offer content.

Feeds 202 may be processed to associate system metadata and/or offer data to one or more offer content contained in the feed 202 or offer(s). System metadata is information associated with attributes of an advertiser, e.g., identification information, such that a local or system key can be created for an offer. Metadata may also be other types of information associated with the offer or feed 202, such as an email address for sending warnings or notifications with any processing issues.

Feeds 202 may also include offer data, which is metadata associated with an offer, or offer content, or any attribute of the offer. Offer data may include an offer key (e.g., a product identifier, such as one that may be used for a product in the advertiser catalog—SKU, product no., etc.) in a given local key space, or other attributes of the offer suitable for creating a unique identifier. Offer data may also be a destination URL for a click, anchor tag text, a short description, offer value, or bid. Such offer data can be normalized, and potentially weighted to ensure equitable treatment or adjusted based on relevance. In some embodiments, offer feeds 202 are exhaustive, while in others feeds are incremental or additive.

The metadata or offer data associated with each feed 202 or offer provides a means for categorizing and tracking the offers to allow operations to seek, update, or mark offers. The tagging engine 214 allows for synthesis and analysis to categorize offers for matching to publisher content. For example, the processing and tagging of offers allows the monetization server 216 to assess the relevance of the offer to targets (publisher/users) when determining which offers to submit or assign. The tagging engine 214 may be the Graffiti system described in U.S. application Ser. No. 12/950,169.

Tagging engine 214 receives offer content, processes the offer content to extract useful information, and provides access to the offer content for publishing, runtime processing, and analysis. Tagging engine includes a parsing module 215 which parses and analyzes the offer content and performs one or more of the following operations: define a tag(s), define a term(s) or attribute(s), define a topic(s), and/or provide an interface for manually introducing defined topics.

Parsing module 215 can define a notion of a tag, which has a representation that can semantically describe offer content, as well as metadata, such as links to other tags, documents or topics, thereby placing the tag in an ontology or other set of tags. A tag may be defined by any word, string, topic, and/or term that describes offer content or has an associated meaning (e.g., metadata). For example, a tag may be a topic describing a classification for an offer or an offer term contained in a document.

Parsing module 215 can define a notion of a term or terms of an offer or offer content from a feed 202 that is useful in describing the offer, such as a keyword. Parsing module 215 can also define a notion of a topic, e.g. a term that is also useful as a category. Parsing module 215 can also provide an interface for permitting manually defined topics to be introduced, allowing editing of topics, terms, and tags, and providing analytical data regarding offer content and the creation and use of tags and topics.

Tagging engine 214 associates tags with offers based on offer content as previously described (e.g., as defined by parsing module 215), and stores the tags in database 212. Other data for offers may be stored in the database 212 to be harvested by the parsing module 215. In some embodiments, the tagging engine 214 may be a service provided by a commercial software product or solution. Tags may be categorized or sorted into tag sets.

The tagging engine 214 may be configured to automatically associate tags to incoming offers or updates to offers. In some embodiments tagging may be done manually, such as when manually tagging emergency updates occur, or when editors annotate content through their publishing system. Any offers that do not validate for any reason will be skipped and the remaining offers processed. Status updates may be notified by the email address for that feed. The advertiser email address is used by the system for warnings or notifications with any processing issues.

In some embodiments, keywords or terms, such as terms from a search query, may be evaluated for tagging by the tagging engine 215. For example, if a user types “american idol” as a search query and then navigates to a publisher page related to the term, the terms may be earmarked for tagging that page by tagging engine 215. In other embodiments, terms may be extracted for tagging from a URL containing one or more of the terms. For example, in the URL “http://www.mysite.com/american-idol-winner-announced/123.html”, keywords “American idol winner” may be extracted and associated with that page. Keywords/terms from a search query and/or URL links may be yet another attribute that can be associated with an offer or offer content, e.g., offer or link to an offer found on a webpage.

The monetization server 216 responds to a request from a client 140, such as an HTTP call, and returns the best matching offer or offers for that client site. Matching an offer to a given a display opportunity is determined by one or more selection algorithms. Input to the matching algorithm is sent with the client request, e.g., HTTP browser cookie, tags, a document identifier associated with tags and metadata, and so on. Any number of parameters may be indicated in the request. For example, a parameter request for matching may be a page URL. The parameter request may also include a list of keywords that match offer content or portions of the URL. Other request parameters include response format (implies width and height, number of offers, text vs. image), API key (publisher id), Internet Protocol (IP) address, HTTP browser cookies, and other environmental variables.

In operation, the monetization server 216 receives the required parameters for an offer selection request. The parameters may be received by automated means, manually, or a combination. Parameters may be any kind associated with an offer, including but not limited to URLs, offer size (implies # of text links), keywords, IP address, user environment, and HTTP browser cookie.

In response to receiving the parameter input(s), the monetization server 216 always returns a non-empty response. For example, since the system 200 goal is to maximize global revenue long term, an ideal response is selected because it best satisfies the long term goal. Other responses are possible, depending on the input(s), such as responding to the need to test or learn about a particular offer.

The monetization server 216 may utilize templates for responding to requests, and provide styling capability. Any templates may be utilized, whether they are standard templates (e.g., Adsense templates) or customized for a particular subscriber, user, group, or entity.

The monetization server 216 may additionally be configured to accommodate JavaScript and other functional or object-based programming.

A selection engine 220 works in conjunction with the monetization server 216 and utilizes one or more selection algorithms based on user requests or predetermined criteria to match offers to requests or target destinations. In some embodiments, the features of the monetization server 216 and the selection engine 220 are of the same machine or computing device. The selection algorithm may be isolated and is modifiable. The selection engine 220 may also be enabled to allow multiple selection algorithms to run concurrently, and to evaluate which ones perform the best.

In some embodiments, selection of an offer may be limited by a time budget, e.g., 100 milliseconds. The selection engine 220 may be configured to identify and consider attributes or hints from a destination page when making a selection. In addition, other information may be utilized, for example information about the user/target, including specific attribute values or HTTP browser cookies and other user-based or target destination attributes when determining the offer selection. The offer selection algorithm may consider tagging information associated with the offer by tagging engine 214 for contextual matching.

In some embodiments, the selection algorithm may include a built-in expectation that the server 216 maximizes revenue or projected revenue when making offer selections. In some embodiments, an offer may be selected for some other criteria or purpose, e.g., based on learning. Selection operations may be automated, manually determined, or a combination of both.

Once one or more relevant offers are selected, the offers are sent to the publishers 230 for displaying the offer to users or targets at one or more clients 240A-D. Publishers may be subscribers to the monetization system 210 who have their own networks or have an associated webpage(s), such as CBS, ESPN, Weather.com, Turner Networks, Forbes and Gawker. Publishers 230 can also be advertisers in that they may submit offers for processing by the monetization configurator 210 to display the offers on their webpages or the webpages of other publishers 230.

The offers may be formatted by the monetization configurator 210, such as by the monetization server 216 or selection engine 220, for display on publisher pages at the user or target sites. The types of formats may be determined by the subscribing publisher 230, e.g., Google AdSense style offer, or may be a format type supplied by the monetization configurator 210. Offer formats may be created using HTML, JSON, and JavaScript or in combination with each other and/or other formats.

Publisher pages or target sites include search results pages generated by a search engine, websites, mobile websites and applications on mobile devices, and so on maintained by publishers 230 or otherwise. The offers may be formatted by the monetization configurator 210, such as by the monetization server 216 or selection engine 220, for display on publisher pages at the user or target sites. The types of formats may be determined by the subscribing publisher 230, e.g., Google AdSense style offer, or may be a format type supplied by the monetization configurator 210. Offer formats may be created using HTML, JSON or in combination with each other and/or other formats. One implementation includes, for example, creating a JavaScript library that allows a publisher 230 to drop an offer packaged by the monetization configurator 210 in a webpage with as few parameters as possible. For example, Google AdSense is a display format for online publishers to displaying relevant ads on a wide variety of online content to earn revenue.

Target data may be stored in database 212 and used by the monetization configurator 210 in determining best matched offers for that particular target. Part of the targeting strategy also includes ways to enhance matching of offers to one or more targets over time. In some embodiments, contextual matching using search engine optimization keywords from a URL or the page title; tracked user, advertiser, or publisher data; or some combination may be utilized. The monetization server 216 allows targeting based on other attributes as well, such as user behavior attributes, to learn how to enhance the matches. Thus, the monetization configurator 210 may have some control in the client (ranging from full control to limited control) to implement the target strategy, and the capability to iterate through many selection algorithms in the server 216. For example, the monetization configurator 210 may make offer selections to match to target sites based on one or more algorithms based on attributes of the target sites or input from the publisher subscriber 230. The attributes of target sites and publisher 230 preferences may be provided manually or in an automated manner when the monetization configurator 210 accesses preference data from client devices of publishers 230 or target sites 240.

Some attributes for targeting include:
1. GUID—a Global Unique Identifier for a publisher page
2. URL
3. Search Engine Optimization (SEO) Keywords from the URL
4. Tags from the native tagging systems.
5. A hash code associated with the body text of a page

In some embodiments, constraints may be implemented when an offer is matched. Examples of constraints include, but is not limited to
1. Spend cap (click cap)
2. Impression restriction (domestic vs. international, competitive exclusion, other features offered by Adsense or other ad network products)
3. Showing only one version of some offer in a response, where multiple versions (formats) exist for an offer exist in the pool
4. Blocking certain offers on certain sites, e.g. in response to complaints

Constraints may be requested by the publisher 230 or subscriber, selected from a predetermined list of requests or the requests may be customized. Constraints may also be determined by the advertisers 204 and the offers that are supplied. The monetization configurator 210 can be configured to anticipate some customization requests. For example, offer selections may be modified based on the matched site or domain for any particular offer. Another example uses a geographical IP address library, so for a given IP address, the monetization configurator 210 considers whether the offer needs to be modified based on international or domestic (location-specific) standards. The monetization configurator 210 may track various behavior patterns or interactions with the offers such as tracking offer display and clicks, and also use certain codes to trace revenue in profit centers. Constraints may also be defined in the advertiser's 204 feeds 202 and processed when the monetization configurator 210 detects them.

Offers may be additionally filtered based on other variables, such as considering the notion of boosting the score or weight of an offer, locking a particular offer into place for some set of pages for a given publisher, overriding the selection mechanism with a particular offer, and other controls indicative of inclusions or exclusions for a given offer or content within an offer. One or more selection algorithms may apply based on the variables for selection of one or more offers. The variables may be automatically assigned, manually determined, or a combination of both.

The monetization configurator 210 may also be designed for tracking various activities or responses to offers. For example, tracking offer display and clicks by users who interact with a published offer and other downstream events. Additionally, revenue associated with an offer may be traced in profit centers. There are at least two contexts for tracking: at the publisher 230, which is where an ad appears, and at the advertiser 204. For example, if a game from the CNET™ catalog appears on the GameSpot™ site, CNET™ is the advertiser, and GameSpot™ is the publisher. Information from the advertiser data warehouse may be utilized to track the advertiser 204 actions, while also appending some information about the publisher 230 as well. The advertiser 204, the publisher 230, and end-user at clients 240 may be tracked and information may be appended to each associated with a particular offer.

In some embodiments, tracking tools can be used. For example, consider an implementation using an Adobe flash client: A given offer from the monetization configurator 210 can be tracked using the following:

The Shockwave Flash will serve the 1×1 pixel, interpolating a publisher site identifier at runtime. Offers will be prepended with a tracking tool 302 redirect, which will also have a variable for identifying the publisher site, e.g.,
sid=${PUB_SITE_ID}

Using this sample method, offer displays and clicks by site can be tracked for the particular offer from the monetization configurator 210.

Destination URLs may also be tracked by the tracking tool. For example, publisher site id may be added into destination URLs for the above illustration. If a publisher site ID is not passed in, the value 0 may be assigned.

To illustrate, CNET™ destination URLs, in the form used by CNET.com™ are described. For CNET™ destination URLs, an offer is tagged to specify the publisher site, for example:
tag=rsm.${PUB_SITE_ID}

where tag is the URL query parameter to specify the CNET™ publisher site of the monetization application. The value may be hard-coded to provide leads by the publisher and advertiser of the CNET™ site.

In a second illustration, promotion codes are utilized in BNET™/TechRepublic™ offers. A reserved range for the promotion is defined. This takes the place of tag in the CNET™ case. Thus, the destination URL query parameter is redefined as:
promo=123${PUB_SITE_ID}

And pub site id may get put into a given value, 0 padded, 3 places. So, for example, site 4 would be:
promo=123004

The following are examples of setting destination URLs for tracking, as illustrated above:
Given the destination URL:
http://dw.com.com/rubicsclk?ver=2&ts=&edId=4282&onId=&ptId=&sId=${PUB_SITE_ID}&appId=2001&offId=1&unitId=

This variable:
sid=${PUB_SITE_ID}

Gets interpolated with a numeric, unpadded ID indicating the site on which the ad is displayed, e.g.:
sid=9

And this sequence:
%2524%257BPUB_SITE_ID%257D

which is the URI-escaped version of the variable ${PUB_SITE_ID}, can be replaced with same numeric value, the site id.

There is a special case for padding:
http://dw.com.com/rubicsclk?ver=2&ts=&edId=4282&onId=&ptId=&sId=${PUB_SITE_ID}&appId=2001&offId=1&unitId=

This sequence:
%2524%257BPUB_SITE_ID_PAD%257D

Must be replaced with a zero-padded site 3 digits long, i.e., given site id 9 would be represented as 009.

Returning to FIG. 2, data collected by the monetization configurator 210 and stored in database 212 may also be analyzed by reporting tool 221 to generate reports. Reporting tool 221 may report on performance metrics, tracking data, revenue data, and other assessment feedback for any given offer. The reporting tool 221 may include a performance dashboard that provides details about the offer down to granularity of the offer. The reporting tool 221 may also provide an administrative dashboard on top of feeds that allows offer management capabilities.

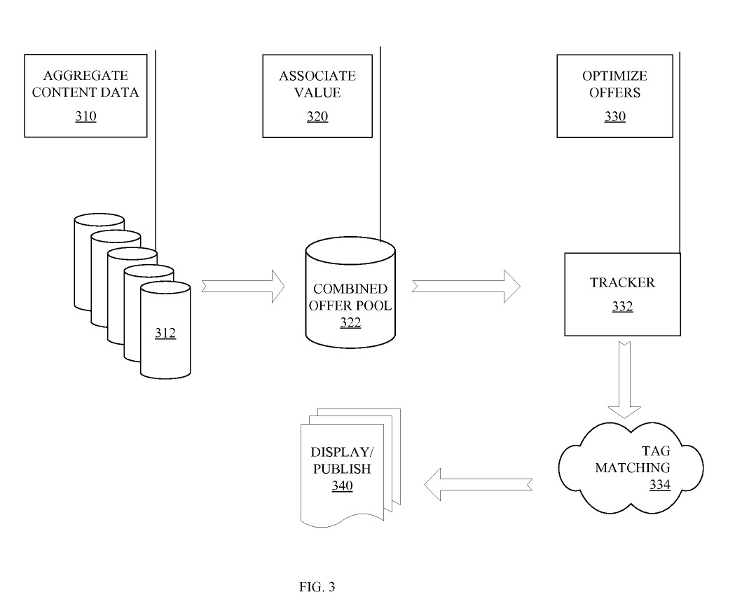

FIG. 3 is a block diagram that represents the operation of the monetization configurator 210 of FIG. 2, according to some embodiments. At an aggregate content data stage 310, the monetization configurator 210 receives offers collected from various content sources. The content is provided by advertisers interested in offering a product or service for value, providing an opportunity to generate revenue from such offers. The offer content is received and stored at 312 for the configurator 210.

At an associate value stage 320, each offer is associated with some value, and disparate offers are united in a single catalog of combined offer pool 322.

At an optimize offers stage 330, the offers are optimized by categorizing, ranking, tracking, and/or updating the offers in the offer pool 322. Tracking and reporting tools, such as tracker 332 allow the configurator 210 to learn how the offers can be optimized based on new or additional information about the offer, such as change in selection request preferences or how the offer is received (e.g., usage patterns, preferences, and action of the subscriber to the selected offers, and so on). The configurator 210 also considers updates and changes to the offers by advertisers. The configurator 210 utilizes selection, filtering, and learning algorithms to dynamically optimize the selection of offers for display.

Offers may also be categorized by associating metadata to each offer by tag matching 334. The metadata association may relate to one or more attributes of the offer and may be used a number of different ways to allow the system to categorize and track offers and make offer selections based on relevance, selection requests, filters, publisher attributes or needs, and other criteria.

Once the offers are optimized and matched to target sites, they can be published and displayed 340 on publisher destination pages. Reactions or responses to the offers may generate offer profits. Once the displayed offers generate revenue, the revenue may be credited back to the advertisers that provide the inventory items.

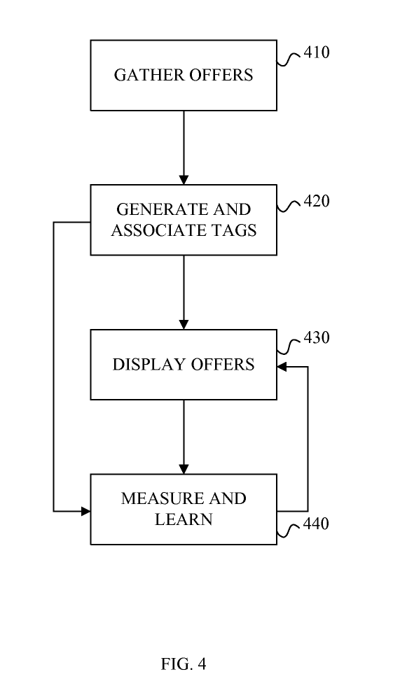

FIG. 4 is a flowchart that illustrates a process of the monetization configurator 210 of FIG. 2, according to some embodiments. At step 410, offers are gathered and pooled together for tagging and processing. At step 420, each offer is piped through a tagging engine to generate and associate a tag or metadata to the offer. The metadata tagging allows the offer to be categorized, tracked, and optimized, and also enabling measuring and learning processes to be applied to the offers at step 440. The measure and learn processes utilize one or more selection and optimization algorithms previously described to match offers to publisher sites. The optimization process includes contextual matching between content at publisher sites and offer(s) or offer content(s), evaluating user/target attributes (e.g., history, geographic or demographic data, etc.), and predicting outcomes (e.g., “propensity to click” per use per offer). With each iteration of piping the offer through the measuring and learning process at step 440, the system updates and learns to better optimize each offer. The learning process may be automated or may include a combination of automated and manual processes. At step 430, the offers are appropriately displayed and updated as the offers are optimized at each destination site.

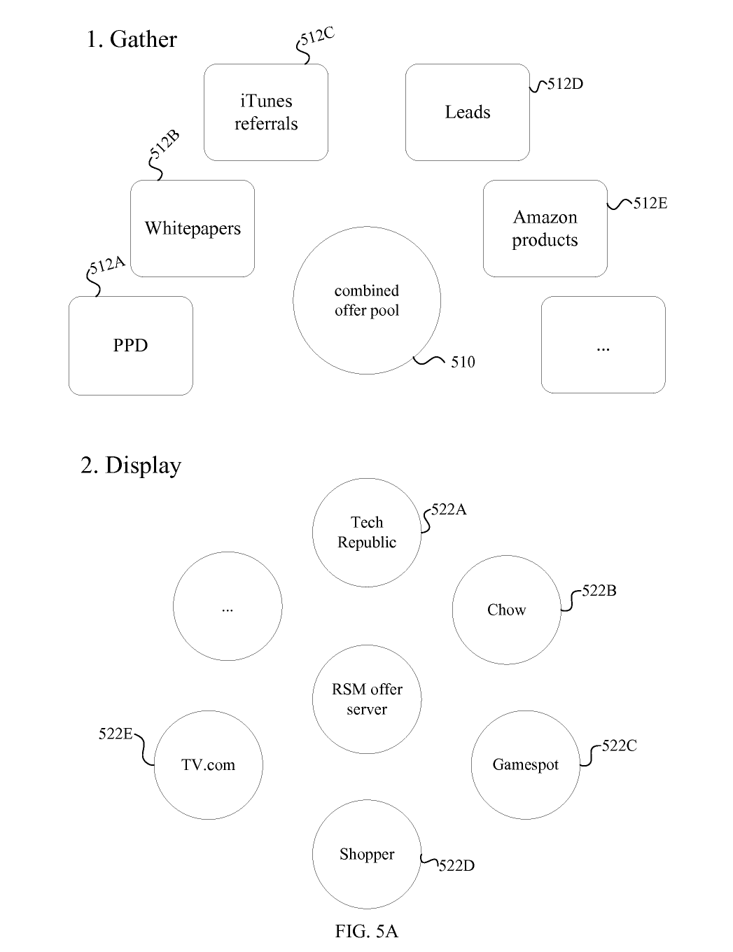

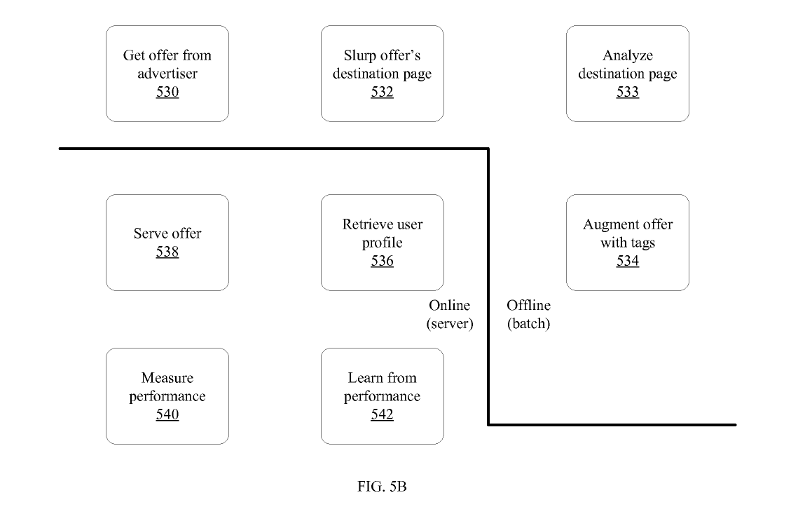

FIGS. 5A-B illustrates, in more detail, the steps of gathering and displaying, according to some embodiments. Advertisers provide offers from a number of different sources, and the monetization configurator 210 aggregates the offers into a combined offer pool 510, as shown in FIG. 5A. Examples of offer sources include, but are not limited to, PPDs 512A, whitepapers 512B, iTunes referrals 512C, leads 512C, Amazon products 512E, and so on. An offer can be anything that can be suitably formatted (e.g., has a headline, body and destination URL), has the ability to generate direct revenue (e.g. Amazon products, pay-per-download software, whitepapers, iTunes, consumer electronics leads), and has a known dollar value.

FIG. 5A also includes an illustration of the monetization offer server 520 display of offers at various publisher sites. Brands provide inventory items for which the offers are displayed, and share in the revenue generated within their inventory. Brands may be third-party product or service providers, but may also be the advertisers and/or publishers. Examples of brand sites where offers may be displayed include, but are not limited to, Tech Republic 522A, Chow 522B, Gamespot 522C, Shopper 522D, TV.com 522E, and so on.

FIG. 5B shows a learning operation of the monetization configurator 210, according to some other embodiments. The monetization configurator 210 may be configured to learn about offer(s) and performance of offers using optimization or learning algorithms to improve and update offers. For example, the monetization configurator 210 may increase its yield by making smart guesses about where and when each offer may be relevant or more profitable. Relevance determinations are made due to the text-to-tagging method for each offer, e.g. by the Graffiti system.

At the back end (offline) the monetization configurator 210 also has the ability to learn, over time, which offers perform well in various contexts, e.g. tracker 332 behavioral optimization. The learning process begins by receiving an offer from advertisers at step 530. The configurator 210 may also include functionality for slurping or crawling the offer's destination page 532 for information that may enhance or improve the offer. Information from the destination page 533 is analyzed, and the knowledge gained may then be used to augment the offer with one or more tags 534.

At the front end (online), offers are selected and served 538 according to selection algorithms or criteria determined by associated tags. User profile information is retrieved 536 as a user interacts with the offer. Performance measurements are conducted 540 as each user interacts with the offer and information learned from the performance 542 is collected and additionally utilized to further augment the offer with one or more tags or by updating existing tags.

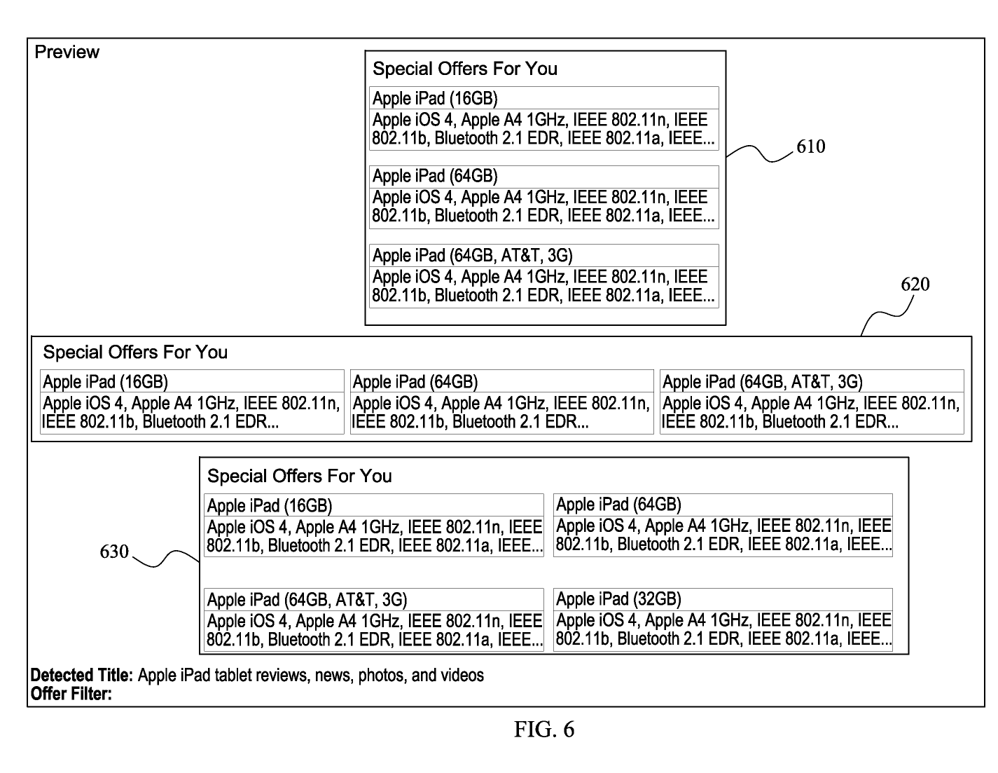

FIG. 6 is a screenshot illustration of various offer displays, according to some embodiments. In this screenshot example, an offer for Apple iPads is matched to a target webpage for publisher CNET.com™. A first sample display 610 shows three different Apple iPad products, which may have been selected by the monetization configurator 210 based on publisher and/or user expectations. For example, the publisher's particular webpage design layout may require the product items to be stacked in a vertical column. Additionally, the three iPad products may have been selected based on the particular user's profile. In a second sample display 620, a different layout for the webpage of the publisher CNET.com™ may require the different iPad products to be displayed horizontally, the same three iPad products being the same for the same user profile. In a third sample display 630, a different set of iPad products are provided based on a user profile that is different from user profile of displays 610, 620.

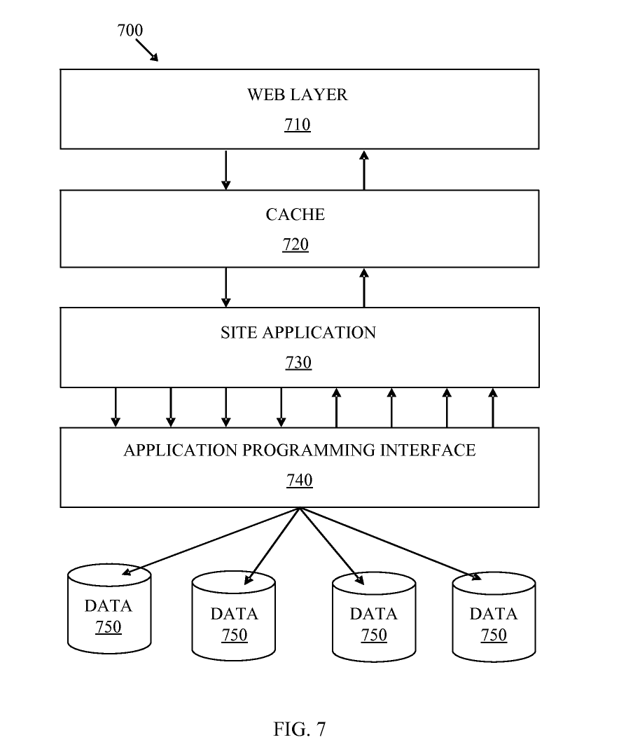

As shown in FIG. 7, system architecture 700 includes web layer 710, cache 720, site application 730, application programming interface 740, and a plurality of data stores 750. It will be appreciated that the system architecture may vary from the illustrated architecture. For example, web layer 710 may directly access data stores 750, the site application may directly access data stores 750, system architecture 700 may not include cache 720, etc., as will be appreciated by those skilled in the art. Data stores 750 include a repository of data in accordance with any manner previously described. Web layer 710 is configured to receive data relating to offers and serve data relating to offers (collectively “data activity”) that have be processed by the monetization configurator 210 of FIG. 2, and, for example, to be served to a destination site. Web layer 710 communicates data activity to cache 720. Cache 720 is configured to temporarily store content that is accessed frequently by web layer 710 and can be rapidly accessed by web layer 710. In one embodiment, cache 720 may be a caching proxy server. Cache 720 communicates data activity to site application 730.

Site application 730 is configured to update cache 720 and to process data activity received from web layer 719. Site application 730 may identify that the data activity is for a page that includes other data from multiple sources. Site application 730 can then convert the page request into a request for content from multiple sources and transmits these requests to application programming interface 740. Application programming interface 740 is configured to simultaneously access data from the plurality of data stores 750 to collect the data responsive to the plurality of requests from site application 730. The plurality of data stores 750 may include, for example, offer data (offers, content in offers, feeds, and son), destination sites, user profile information, target data, and the like. It will be appreciated that in alternative embodiments only one data store 750 may be provided to store the data.

The data in data stores 750 is provided to application programming interface 740, which provides the content to site application 730. Site application 730 updates cache 720 and delivers the cached content in combination with the accessed content to web layer 710, which delivers content to the destination site.

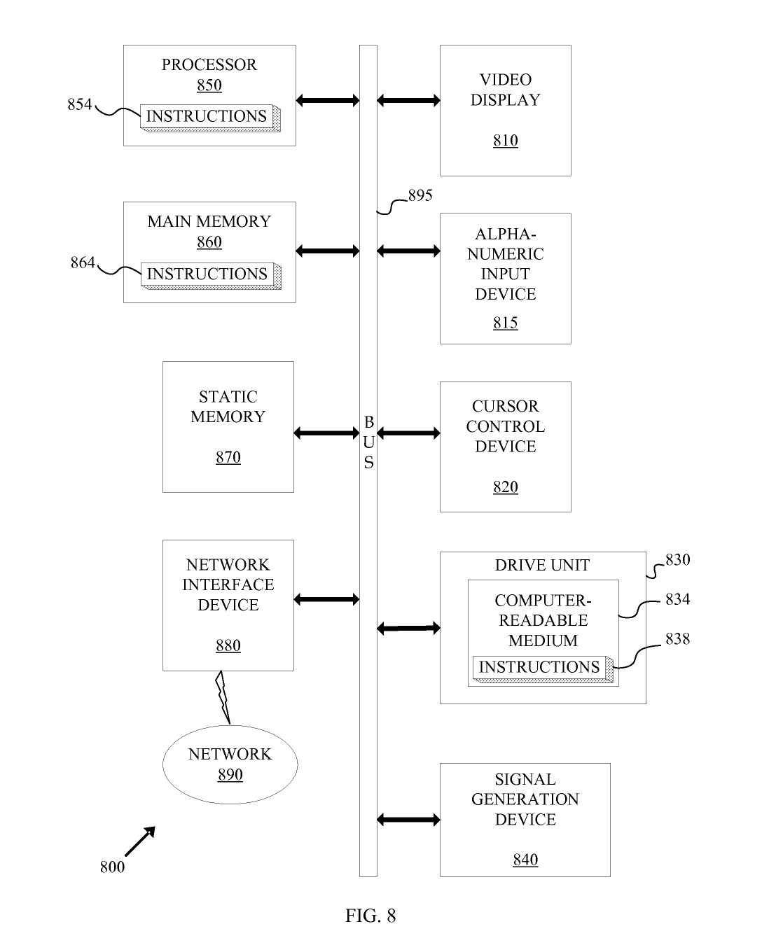

FIG. 8 shows a diagrammatic representation of a machine in the exemplary form of computer system 800 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Computer system 800 includes processor 850 (e.g., a central processing unit (CPU), a graphics processing unit (GPU) or both), main memory 860 (e.g., read only memory (ROM), flash memory, dynamic random access memory (DRAM) such as synchronous DRAM (SDRAM) or Rambus DRAM (RDRAM), etc.) and static memory 870 (e.g., flash memory, static random access memory (SRAM), etc.), which communicate with each other via bus 595.

Computer system 800 may further include video display unit 810 (e.g., a liquid crystal display (LCD) or a cathode ray tube (CRT)). Computer system 800 also includes alphanumeric input device 815 (e.g., a keyboard), cursor control device 820 (e.g., a mouse), disk drive unit 830, signal generation device 840 (e.g., a speaker), and network interface device 880.

Disk drive unit 830 includes computer-readable medium 834 on which is stored one or more sets of instructions (e.g., software 838) embodying any one or more of the methodologies or functions described herein and causing a processor, such as processor 850, to carry out those functions when executed. Software 838 may also reside, completely or at least partially, within main memory 860 and/or within processor 850 during execution thereof by computer system 800, main memory 860 and processor 850 also constituting computer-readable media. Software 838 may further be transmitted or received over network 890 via network interface device 880.

While computer-readable medium 834 is shown in an embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the machine and that cause the machine to perform any one or more of the methodologies of the present description of the technology. The term “computer-readable medium” shall accordingly be taken to include, but not be limited to, solid-state memories, and optical and magnetic media.

The functions of the embodiment can be described as modules of computer executable instructions recorded on tangible media. The modules can be segregated in various manners over various devices.

The description of various embodiments can be applied to any type of content, such as multimedia content, including video content to be downloaded or streamed.

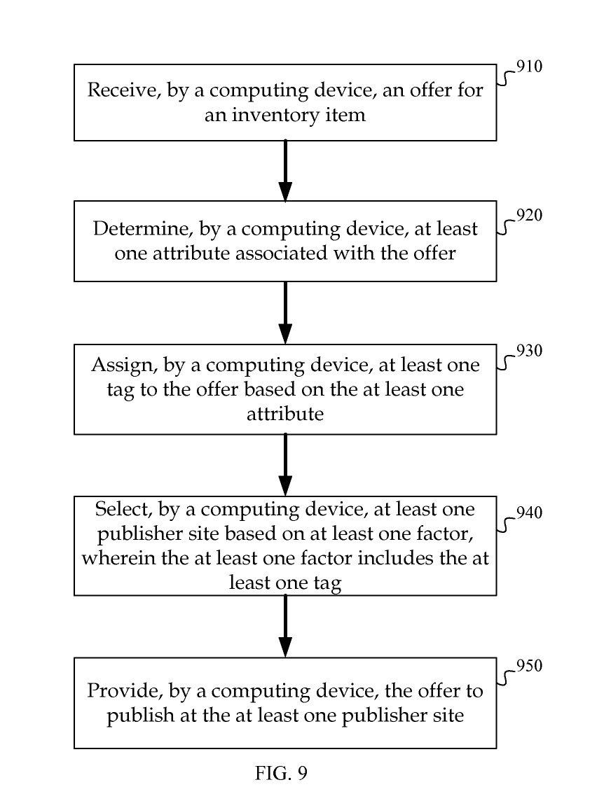

FIG. 9 is a flow diagram illustrating the operation of an offer monetization system, according to some other embodiments. At step 910, offer for an inventory item is received by a computing device. At step 920, at least one attribute associated with the offer is determined by a computing device. At step 930, at least one tag to the offer is assigned by a computing device based on the at least one attribute. At step 940, at least one publisher site is selected by a computing device based on at least one factor, wherein the at least one factor includes the at least one tag. At step 950, the offer is provided by a computing device to publish at the at least one publisher site.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present description of technology has been described in relation to particular examples, which are intended in all respects to be illustrative rather than restrictive. Those skilled in the art will appreciate that many different combinations of hardware, software, and firmware will be suitable for practicing the present description of the technology.

The one or more of the various embodiments described is achieved by manipulating data structures and transforming the data from one form, useable by a computer for one purpose, to another form, useable by a computer for another purpose.

Other implementations of technology will be apparent to those skilled in the art from consideration of the specification and practice of the various embodiments disclosed herein. Various aspects and/or components of the described embodiments may be used singly or in any combination. It is intended that the specification and examples be considered as embodiments of the technology, with a true scope and spirit of the invention(s) being indicated by the following claims.

What is claimed:

1. A method for presenting an offer, comprising:
receiving, by a computing device, an offer for an inventory item;
determining, by a computing device, at least one attribute associated with the offer;
assigning, by a computing device, at least one tag to the offer based on the at least one attribute; and
selecting, by a computing device, at least one publisher site based on at least one factor, wherein the at least one factor includes the at least one tag.

2. The method of claim 1, further comprising selecting, by a computing device, at least one publisher site based on at least a second factor that includes at least one attribute associated with a web page navigated to by a user.

3. The method of claim 1, further comprising providing, by a computing device, the offer to publish at the at least one publisher site.

4. The method of claim 1, further comprising:
receiving, by a computing device, data associated with the offer;
updating, by a computing device, the offer based on the data and the associated at least one tag; and
replacing, by a computing device, the offer with the updated offer at the selected at least one publisher site.

5. The method of claim 1, wherein the offer is derived from a feed maintained by an advertiser of the offer.

6. The method of claim 1, wherein the at least one attribute associated with the offer is derived from information in a Uniform Resource Locator (URL).

7. The method of claim 1, wherein the offer is derived from a website crawled for offer information.

8. The method of claim 1, wherein the at least one tag includes metadata associated with the offer or the at least one attribute of the offer.

9. The method of claim 1, wherein the inventory item is a product or service advertised on the Internet.

10. The method of claim 1, wherein the act of selecting at least one publisher site based on at least one factor, includes selecting the at least one publisher site based on a plurality of factors, wherein the plurality of factors includes a relevance calculation and profitability determination.

11. The method of claim 10, wherein the relevance calculation includes an algorithm that takes into account one or more factors in a group consisting of: age of the offer, an update to the offer, a modification to the offer, a profitability value, a bid for the offer, and user profile information.

12. The method of claim 1, wherein the offer generates revenue and has a known value.

13. The method of claim 1, further comprising tracking responses to the offer published at the at least one destination site.

14. The method of claim 1, wherein the inventory item is digital content.

15. An apparatus for presenting an offer within a digital content environment, said apparatus comprising:
memory;
one or more programs stored in the memory; and
one or more processors configured to execute the one or more programs, the one or more programs comprising instructions to:
receive an offer for an inventory item;
determine at least one attribute associated with the offer;
assign at least one tag to the offer based on the at least one attribute; and
select at least one publisher site based on at least one factor, wherein the at least one factor includes the at least one tag.

16. The apparatus of claim 15, wherein the one or more programs further comprise instructions to select the at least one publisher site based on at least a second factor that includes at least one attribute associated with a web page navigated to by a user.

17. The apparatus of claim 15, further comprising instructions to provide the offer to publish at the at least one publisher site.

18. The apparatus of claim 15, further comprising instructions to:
receive data associated with the offer;
update the offer based on the data and the associated at least one tag; and
replace the offer with the updated offer at the selected at least one publisher site.

19. The apparatus of claim 15, wherein the offer is derived from a feed maintained by an advertiser of the offer.

20. The apparatus of claim 15, wherein the at least one attribute or at least one tag for the offer is derived from a Uniform Resource Locator (URL) for the at least one publisher site.

21. The apparatus of claim 15, wherein the at least one tag includes metadata associated with the offer or the at least one attribute of the offer.

22. The apparatus of claim 15, wherein the inventory item is a product or service advertised on the Internet.

23. The apparatus of claim 15, wherein the instructions to select at least one publisher site based on at least one factor, includes instructions to select the at least one publisher site based on a plurality of factors, wherein the plurality of factors includes a relevance calculation and profitability determination.

24. The apparatus of claim 23, wherein the relevance calculation includes an algorithm that takes into account one or more factors in a group consisting of: age of the offer, an update to the offer, a modification to the offer, a profitability value, a bid for the offer, and user profile information.

25. The apparatus of claim 15, wherein the offer generates revenue and has a known value.

26. The apparatus of claim 14, further comprising instructions to track responses to the offer published at the at least one publisher site.

27. The apparatus of claim 15, wherein the inventory item is digital content.

28. A computer readable storage medium storing one or more programs configured for execution by a computing device, the one or more programs comprising:
instructions for receiving, by a computing device, an offer for an inventory item;
instructions for determining, by a computing device, at least one attribute associated with the offer;
instructions for assigning, by a computing device, at least one tag to the offer based on the at least one attribute; and
instructions for selecting, by a computing device, at least one publisher site based on at least one factor, wherein the at least one factor includes the at least one tag.

29. The computer readable storage medium of claim 28, further comprising instructions for selecting, by a computing device, at least one publisher site based on at least a second factor that includes at least one attribute associated with a web page navigated to by a user.

30. The computer readable storage medium of claim 28, further comprising instructions for providing, by a computing device, the offer to publish at the at least one publisher site.

31. The computer readable storage medium of claim 28, further comprising instructions for:
receiving, by a computing device, data associated with the offer;
updating, by a computing device, the offer based on the data and the associated at least one tag; and
replacing, by a computing device, the offer with the updated offer at the selected at least one publisher site.

32. The computer readable storage medium of claim 28, wherein the offer is derived from a feed maintained by an advertiser of the offer.

33. The computer readable storage medium of claim 28, wherein the at least one attribute or at least one tag for the offer is derived from a Uniform Resource Locator (URL) for the at least one publisher site.

34. The computer readable storage medium of claim 28, wherein the at least one tag includes metadata associated with the offer or the at least one attribute of the offer.

35. The computer readable storage medium of claim 28, wherein the inventory item is a product or service advertised on the Internet.

36. The computer readable storage medium of claim 28, wherein the instructions for selecting at least one publisher site based on at least one factor, includes instructions for selecting the at least one publisher site based on a plurality of factors, wherein the plurality of factors includes a relevance calculation and profitability determination.

37. The computer readable storage medium of claim 36, wherein the relevance calculation includes an algorithm that takes into account one or more factors in a group consisting of: age of the offer, an update to the offer, a modification to the offer, a profitability value, a bid for the offer, and user profile information.

38. The computer readable storage medium of claim 28, wherein the offer generates revenue and has a known value.

39. The computer readable storage medium of claim 28, further comprising instructions for tracking responses to the offer published at the at least one publisher site.

40. The computer readable storage medium of claim 28, wherein the inventory item is digital content.
